(19) United States
(12) Patent Application Publication
(10) Pub. No.: US 2011/0014346 A1
(43) Pub. Date: Jan. 20, 2011

(54) EDIBLE DESSERT PRODUCTS

(76) Inventor: Damian Jon Oracki, London (GB)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/933,023

(22) PCT Filed: Mar. 17, 2009
(86) PCT No.: PCT/GB2009/000714

§ 371 Date: Sep. 16, 2010

(30) Foreign Application Priority Data
Mar. 17, 2008 (GB) 0804986.8

(51) Int. Cl. A21D 13/00

(52) U.S. Cl. 426/549

(57) ABSTRACT

Edible dessert products are produced by taking a sweet baked product, such as a cake or cookie, rendering it into particulate form, and blending it, preferably hot, with a thick custard base. The particulate baked product may be pre-wetted before blending, e.g. using sweetened milk or water and the blending reduces the final particle size of the baked product particles in the matrix of custard base to an average particle size of less than 0.5 mm. The product tastes good and can be consumed hot, at ambient temperature, or frozen.

This invention relates to edible dessert products and methods for their manufacture.

For many centuries, it has been customary in the human diet to consume both sweet and savoury foods. In many cultures, meals often consist of one or more savoury courses followed by a sweet course. Over the centuries, a very wide variety of sweet desserts has been developed, many of them being based on baked farinaceous products, i.e. dessert cakes or pastries.

Separately, a very wide variety of desserts are based on milk, either combined with a staple carbohydrate product such as tapioca, sago or rice, or simply consisting of dairy fat and sugar, optionally with other flavourings, and generally of a creamy texture. One particular dessert of note is ice cream.

Many desserts are constructed of more than one component, and, in particular, a variety of desserts have been developed and commercialised which use both a farinaceous baked component and a dairy or dairy substitute-based cream or frozen cream component. The simultaneous serving of both is widely practised, for example accompanying a slice of cake or pie with a portion of ice cream or custard.

Such combinations are conveniently assembled shortly before consumption, but may be assembled together on an industrial scale, packaged, stored and eventually sold to the consumer for consumption. Such combination desserts have achieved widespread commercial success, for example ice creams having distributed within the body of an ice cream base, pieces of cake, biscuit or cookie.

The patent literature includes a variety of disclosures of such mixtures, especially ones in which the pieces do not lose their texture. Examples are U.S. Pat. No. 4,397,881, U.S. Pat. No. 5,147,669. US-A-2004-0166219, JP-A-2003-052309 and GB2359242. JP-A-6178653 discloses a whipped cream/granular dessert cake mix, and FR-A-220436 discloses a combination of ice cream and biscuit/fat mixture formed into a freezable container for the ice cream.

I have now found that palatable and tasty dessert products may be made by combining baked farinaceous products and dairy or non-dairy-based creamy consistency products, generally called, for simplicity, custards, in a way which intimately admixes the two and where the particle size of the baked farinaceous product is reduced during the admixture to below 0.5 mm.

According to a first feature of the present invention, there is provided an edible dessert product consisting of a homogenous combination of a finely divided baked farinaceous product distributed in a custard base, the average particle size of the baked farinaceous product being less than 0.5 mm and preferably less than 0.2 mm.

In accordance with a separate aspect of the invention, there is provided a method of manufacturing an edible dessert product which comprises making a sweetened baked farinaceous product in known fashion, making a thick custard base, and blending the baked farinaceous product and custard base together by a method which reduces the particle size of the baked farinaceous product to less than 0.5 mm with the particles of baked farinaceous product being evenly distributed in a matrix of the thick custard base.

The blending is preferably carried out by using a high shear blending action, for example achieved using a kitchen or industrial blender with a rapidly rotating set of cutting and mixing blades. This blending action reduces the particle size of the farinaceous product, and blending should be continued until the desired texture is achieved.

Edible dessert products in accordance with the present invention may be consumed at room temperature, heated, or frozen.

The exact taste, texture and feel of the edible dessert product in accordance with the invention will depend on the precise ingredients used to make the baked farinaceous product and the custard base, as well as the proportions and production method used for that, and the precise blending conditions. Generally speaking, most sweet baked farinaceous products may be used to make the dessert product of the present invention and most custard bases. There is a very wide variety of known recipes for both of these two ingredients, which are first produced in separate manufacturing steps. In accordance with the invention, they are then combined together, as noted above preferably using a high speed blending apparatus, to produce the finished dessert product. In order to assist blending, the sweet baked farinaceous product is preferably rendered into particulate form, e.g. by grinding, mincing or pulverising, prior to blending. This may be achieved by any convenient means, for example by using the method of producing “cookie bits” disclosed in GB-A-2359242. The proportions of the ingredients which are then blended together may vary, but will generally be in the range of 40 to 65 percent by weight sweet farinaceous product and 35 to 60 percent by weight custard. Preferably the proportions are within the range 50 to 60 percent by weight sweet farinaceous product and 40 to 50 percent by weight custard.

It is found that the texture of the final product may sometimes be improved by initially reducing the particle size of the baked farinaceous product, wetting the reduced particle size farinaceous product and thereafter blending together with the thick custard base. The blending step is preferably carried out at elevated temperature, for example between 40 and 90° C., preferably between 75 and 80° C.

As noted above, both the baked farinaceous product and the custard may be selected from a very wide variety of such materials made to different recipes and using different ingredients.

In the case of the sweet baked product, the basic farinaceous material may be a normal cereal flour, or it may be a flour derived from other sources, such as potato flour or any of the numerous varieties of leguminous flours. Suitable flours which may be used include amaranth, garbanzo bean, chickpea, corn, millet, oats, potatoes, rice, barley, rye, wheat and soybean. The sweetness may be imparted to the product using normal cooking sugar, or using various other sugars, such as fructose, sorbitol tagatose and xylitol, or using artificial sweeteners, such as aspartame, cyclamate and saccharin. Combinations of natural and artificial sweeteners may be used. The third main ingredient of the mixture which is then baked to make the baked farinaceous product is some form of liquid, for example milk, water, eggs or soya milk. Depending upon the particular sweet baked product desired, the recipe may include conventional additives such as raising agents, texturing agents, bulking agents or the like. The baking time and temperature will be appropriate to the particular recipe in question, and the baked product is preferably cooled before being rendered into particulate form, for example by mincing, grinding or pulverisation.

The custard base may be made according to a very wide variety of known custard recipes, usually consisting of a milk or milk substitute, a sweetener, and egg. The custard base is preferably relatively thick. I have also found that particularly satisfactory tasting and textured final products may be obtained by incorporating a chocolate ingredient into the custard base, for example cocoa butter, white, dark or milk chocolate. It is believed that the thixotropic properties of the cocoa butter impart a smoothness of texture which is particularly satisfying to consumers of the final product.

If, prior to the blending together of the two major ingredients, the particulate sweet baked farinaceous product is wetted, this may conveniently be achieved by the use of any appropriate wetting agent, such as milk or even water. The wetting agent is preferably sweetened, for example by having sugar, starch syrup, reduced starch syrup, maltose syrup, sorbitol syrup or substitutes for any of these dissolved into it. The blending together of the particulate baked farinaceous product with the wetting agent is preferably carried out to produce a dense sticky mass which can then be blended with the custard base.

As noted above, the edible dessert products of the present invention may be consumed at room temperature, heated or cooled, or, indeed, frozen, i.e. cooled to below 0° C. A particular advantage of the products according to the present invention is that if, whether for serving or for longer term storage, they are to be frozen, i.e. reduced in temperature below 0° C., this may be achieved without the need to stir the mixture as it is cooled in order to maintain it homogeneous.

By operating in accordance with the present invention, it is possible to produce desserts which have a different texture from either custard, ice cream or cake, but which reflect the taste of sweet baked cake or like products as well as the texture of thickened semi-solid known dessert materials. By varying the ingredients and by tuning the timing, temperature and blending conditions, it is possible to produce a variety of edible desserts which appeal to different tastes. If desired, after the blending step, which results in a smooth pasty consistency product, that product may be whipped to introduce air and accordingly provide a final product having a mousse texture. The specific flavour of the edible dessert product may be easily influenced in customary fashion by the incorporation of additional flavourings or flavour enhancers into either of the ingredients or into the blending step. Other customary food additives, such as colourants and preservatives, can likewise be introduced.

The dessert of the present invention may also form part of a composite dessert component, for example consisting of the dessert of the invention enrobed with a chocolate or other edible covering, or it may be itself presented in a container such as a pastry case, waffle cup or hollowed out fruit.

The present invention is illustrated purely by way of example with reference to the following four recipes which are set out below. As the basic sweet baked product, these use chocolate brownie, Madeira cake or golden syrup cake. All these can be produced in accordance with standard recipes known for such products.

### EXAMPLE 1

### Ingredients

### 700 g Standard Chocolate Brownie

### 110 g Evaporated Milk

### 75 g 70% Belgian Dark Chocolate

### 1.5 Egg Yolks

### 8 Heaped Teaspoons Caster Sugar

### 150 ml Full Cream

### 90 g Raw Pecan Nuts

### Preparation:

Grind or process the 700 g of chocolate brownie in a food processor until pulverized into small cake crumbs. Place grinded cake into mixing bowl. In a saucepan, slowly heat up the wetting agent of 75 g evaporated milk with 3 heaped teaspoons sugar for about 8 minutes. Stir constantly until sugar is melted and mixture is at a temperature of 80° C.; do not boil. Immediately add the hot wetting agent to the cake crumbs and knead until all the hot liquid is dissolved thoroughly throughout the ground cake crumbs, which should bind together at this point.

Take 220 ml whole milk and heat slowly in a saucepan, stirring constantly. Take off the heat before boiling. Allow to cool. Beat 5 heaped teaspoons of sugar with 1.5 egg yolks until mixed. Add some cool milk from the saucepan, stir and then add the mix to the rest of the milk in the saucepan. Add 75 g 70% Belgian dark chocolate. Slowly heat the mixture while constantly stirring for about 10 minutes until the mixture thickens and begins to form a film over the back of the wooden spoon. Immediately add the hot custard base to the bound cake crumb material in the mixing bowl and grind the mixture with a hand blender for 5 minutes until it acquires a smooth, heavy mousse-like consistency. Allow to cool and blend in the 150 ml of full cream. Thereafter add the 90 g raw pecan nuts. Once thoroughly mixed pour into moulds or containers and subject to blast chilling or freezer for freezing.

### EXAMPLE 2

### Ingredients

### 530 g Plain Madeira Cake

330 g Coconut Bakes [Consisting of: Desiccated Coconut (31%), Sugar, Water, Modified Potato Starch, Dextrose, Skimmed Milk Powder, Egg White, Milk Protein, Flavouring, Colour (Annatto), Preservative (Potassium Sorbate)] (ex ASDA Stores Limited bakery called Mini Coconut Bites).

### 400 g Coconut Milk

### 14 Heaped Teaspoons Caster Sugar

### 2 Egg Yolks

### 100 g White Chocolate

### 30 g Creamed Coconut

100 g Full cream or coconut cream

### Preparation:

Grind Madeira cake together with coconut bites in a food processor until the products are pulverised into small crumbs. Mix the pulverized bakes together until evenly spread throughout each other. Heat 184 g coconut milk with 6 teaspoons sugar, stirring constantly until sugar dissolved and liquid is hot. Immediately mix liquid to pulverised bakes for pre-bonding.

Take 216 g coconut milk and heat slowly in a saucepan, stirring constantly. Take off the heat before boil. Allow to cool. Beat 8 heaped teaspoons of sugar with 2 egg yolks until mixed. Add some cool milk from the saucepan, stir and then add the mix to the rest of the milk in the saucepan. Add 100 g white chocolate. Slowly heat the mixture and add 30 g Creamed Coconut while constantly stirring for about 10 minutes until the mixture thickens and begins to form a film over the back of the wooden spoon. Immediately add the hot liquid base to pulverised bakes in the mixing bowl and grind the mixture with a hand blender for 5 minutes until it acquires a smooth, heavy mousse-like consistency. Allow to cool and blend in the 100 full cream or coconut cream. Once thoroughly mixed, pour into moulds or containers and subject to blast chilling or freezer for freezing.

### EXAMPLE 3

### Ingredients

### 973 g Madeira Cake

### 464 ml Strawberry Milk

### 12 Heaped Teaspoons Caster Sugar

### 60 g Full Cream

### 2 Egg Yolks

### 300 g Cream Cheese

### 120 g White Chocolate

200 g Freshly Sliced Strawberries with 40 g Caster Sugar (optional)

### Preparation:

Grind Madeira cake in a food processor until completely pulverised into small crumbs. Slowly heat 214 ml strawberry milk with 4 heaped teaspoon sugar, stirring constantly until sugar dissolved and liquid is hot. Immediately mix liquid to pulverised Madeira cake for pre-bonding. Take 250 ml strawberry milk and heat slowly in a saucepan, stirring constantly. Take off the heat before boil. Allow to cool. Beat 8 heaped teaspoons of sugar with 2 egg yolks until mixed. Add some cool milk from the saucepan to egg yolk and sugar mix, stir and then add the mix to the rest of the milk in the saucepan. Add 120 g white chocolate. Slowly heat the mixture while constantly stirring for about 10 minutes until the mixture thickens and begins to form a film over the back of the wooden spoon. Immediately add this hot liquid base to pulverised Madeira cake in the mixing bowl and grind the mixture with a hand blender for 5 minutes until it acquires a smooth, heavy mousse-like consistency. Allow to cool and blend in 250 to 300 g cream cheese. An optional addition of freshly sliced strawberries with caster sugar can be added. Once thoroughly mixed, pour into moulds or containers and subject to blast chilling or freezer for freezing.

### EXAMPLE 4

### Ingredients

### 1120 g Golden Syrup Cake

### 200 g Evaporated Milk

### 11 Heaped Teaspoons Caster Sugar

### 1 Teaspoon Vanilla Essence

### 300 g Whole Milk

### 2 Egg Yolks

### 150 g Belgian Milk Chocolate

### 100 g Crushed Peanuts

### 50 g Full Cream

### Preparation:

Grind 1120 g golden syrup cake in a food processor until completely pulverised into small crumbs. Slowly heat 200 g evaporated milk with 3 heaped teaspoons caster sugar and vanilla essence, stirring constantly until sugar dissolves and liquid is hot. Immediately mix liquid to pulverised golden syrup cake for pre-bonding. Take 300 g whole milk and heat slowly in a saucepan, stirring constantly. Take off the heat before boiling. Allow to cool. Beat 8 heaped teaspoons of sugar with 2 egg yolks until mixed. Add some cool milk from the saucepan to egg yolk and sugar mix, stir and then add the mix to the rest of the milk in the saucepan. Add 150 g Belgian milk chocolate to saucepan. Slowly heat the mixture while constantly stirring for about 10 minutes until the mixture thickens and begins to form a film over the back of the wooden spoon. Immediately add this hot liquid base to pulverised golden syrup cake in the mixing bowl and grind the mixture with a hand blender for 5 minutes until it acquires a smooth, heavy mousse-like consistency. Allow to cool and blend in 50 g full cream and crushed peanuts. Once thoroughly mixed, pour into moulds or containers and subject to blast chilling or freezer for freezing.

1. An edible dessert product consisting of a homogenous combination of a finely divided baked farinaceous product distributed in a custard base, the average particle size of the baked farinaceous product being less than 0.5 mm.

2. A product according to claim 1 wherein the average particle size of the baked farinaceous product is less than 0.2 mm.

3. A method of manufacturing an edible dessert product which comprises making a sweetened baked farinaceous product in known fashion, making a thick custard base, and blending the baked farinaceous product and custard base together by a method which reduces the particle size of the baked farinaceous product to less than 0.5 mm with the particles of baked farinaceous product being evenly distributed in a matrix of the thick custard base.

4. A method according to claim 3 wherein the blending is carried out by using a high shear blender.

5. A method according to claim 3 wherein, prior to blending, the sweet baked farinaceous product is rendered into particulate form by grinding, mincing or pulverising.

6. A method according to claim 3 wherein the proportions blended are 40 to 65 percent by weight sweet farinaceous product and 35 to 60 percent by weight custard.

7. A method according to claim 3 wherein the baked farinaceous product is reduced in particle size and wetted prior to blending together with the thick custard base.

8. A method according to claim 3 wherein the blending step is carried out at elevated temperature between 40 and 90° C.

9. A method according to claim 3 wherein, after blending, the blended mixture is cooled to below 0° C.

10. A method according to claim 3 wherein the thick custard base includes a proportion of a chocolate ingredient.

11. A method according to claim 3 and further including a final step of at least partly surrounding a portion of the blended mixture in a relatively solid casing.

12. A product made according to the method of claim 3.
